(19) United States
(12) Patent Application Publication
(10) Pub. No.: US 2006/0174716 A1
(43) Pub. Date: Aug. 10, 2006

(54) Magnetic-inductive flowmeter

(75) Inventors: Kathrin Zajac, Gottingen (DE); Bernd Schneider, Hardeqsen (DE); Dieter Keese, Wahlsburg (DE); Ralf Backer, Bovenden (DE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: ABB Patent GmbH, Ladenburg (DE)

(21) Appl. No.: 11/334,362

(22) Filed: Jan. 19, 2006

(30) Foreign Application Priority Data
Jan. 21, 2005 (DE) 10 2005 002 907.8

(51) Int. Cl. G01F 1/58

(52) U.S. Cl. 73/861.12

(57) ABSTRACT

Magnetic-inductive flowmeter, formed from a piece (1, 1a) of a pipeline (40) which has already been permanently installed in situ and in which a fluid is flowing at least temporarily, in that an electrode arrangement (32, 32a) is introduced into the piece (1, 1a) of the pipeline (40) which has already been permanently installed, and a magnet system (14) is fixed to the piece (1, 1a) of the pipeline (32, 32a) which has already been permanently installed, in the area of the electrode arrangement (32, 32a).

The invention relates to a magnetic-inductive flowmeter for measurement of the flow of fluid substances through a pipeline which has already been permanently installed in situ and in which a fluid is flowing at least temporarily, according to the precharacterizing clause of Claim 1.

Magnetic-inductive flowmeters which are already known from the prior art are separate instruments which during their use are installed in the pipeline in which they are intended to measure the flow of a flowing fluid substance. The magnetic-inductive meters are in this case generally installed by means of flange connections.

The basic design and the method of operation of magnetic-inductive meters are described, for example, in the German-Language Dictionary of Measurement and Automation, published by Elmar Schrufer, VDI-Verlag; Dusseldorf 1992, pages 262-263. By virtue of the principle of operation, magnetic-inductive meters can be used only for the measurement of the flow of electrically conductive fluid substances. In this case, the expression fluid substances is intended to be primarily a liquid, although it could also be a gas.

Magnetic-inductive meters are used in a range of industrial process installations, for example in the field of waterworks (flow measurement in drinking water processing and waste water processing), in the field of the chemical and petrochemical industries (flow measurement of water, acids, lyes etc.), in the field of the pharmaceutical industry or in the field of the foodstuffs industry (flow measurement of water, juices, beer, milk products, etc.).

The production of a flange connection between the flowmeter and the endpieces of the pipeline, as is required for installation of known magnetic-inductive flowmeters, represents a considerable cost factor. For this purpose, in a pipeline which has already been permanently installed in situ, the appropriate mating flanges must have already been provided at the intended installation location, or they must be fitted retrospectively. Overall, the procedure for installation of a magnetic-inductive flowmeter is highly complex.

The object of the present invention is thus to provide a magnetic-inductive flowmeter which can be installed more easily and at a lower cost in a pipeline which has already been permanently installed in situ.

The object is achieved by a flowmeter of this generic type having the characterizing features of claim 1.

According to the invention, the flowmeter comprises a piece of the pipeline which has already been permanently installed in situ, in which an electrode arrangement is introduced and to which a magnet system is fixed in the area of the electrode arrangement.

The advantage of a flowmeter device according to the invention is that there is no longer any need to retrospectively install a separate magnetic-inductive flowmeter in the pipeline, but that the process pipeline is itself effectively used as the meter. The process pipeline is in this case itself provided with a flow measurement functionality at those points at which the flow is intended to be measured, also referred to in the following text as measurement points, by integration of an electrode arrangement in the pipeline, and by fixing a magnet system to the pipeline.

In a first advantageous refinement of the invention, the electrode arrangement is introduced into the piece which forms the measurement point and the magnet system is fixed to said piece before final installation of the pipeline. The piece is then connected thereto on completion of the pipeline in the same manner that is used to connect the other pieces of pipe to one another. No expensive flange connection methods are used in this case, but low-cost methods such as welding methods, sleeve connections, clamp connections or similar pipe connecting methods which are known from the prior art.

In a second advantageous refinement of the invention, the electrode arrangement is retrospectively introduced into the piece which forms the measurement point and the magnet system is fixed to said piece, retrospectively after final installation of the pipeline. In this case, there is no longer any need for any significant intervention in the finally installed pipeline. In particular, this refinement can be used advantageously in the low-pressure range, for example for drinking water or waste water lines, because the electrodes which are introduced into the pipeline at the measurement point can be sealed there in a simple manner using conventional and known sealing methods.

In a further advantageous refinement of the invention, at least the piece at the measurement point is a plastic pipe composed of polyethylene with an additional diffusion barrier formed by an aluminium casing layer. Pipes such as these are used as so-called PE-Hd pipes in the prior art, and are being increasingly used in particular for the transportation of water and gas. In order to add to the known advantages of polyethylene pipes, such as the good corrosion resistance, the simple connection techniques and the good resistance to rapid crack propagation, the characteristic of sealing against the inward diffusion of hazardous substances through the pipe wall, PE-Hd pipes are known which are additionally equipped with an aluminium casing layer and with a further protective casing that is additionally fitted to them. Pipes such as these are manufactured, for example, by the company Egeplast Werner Strumann GmbH & Co KG as so-called SLA-safety drinking water pipes, and are commercially available. When using pipes such as these in a magnetic-inductive flowmeter according to the invention, the aluminium casing layer can be used as a screening layer for the measurement voltage with respect to the excitation voltage of the magnet system, when the electrode arrangement is introduced.

In one advantageous embodiment, the electrode arrangement in this case comprises measurement and earthing electrodes which are introduced in a fluid-tight manner into the wall of the piece of the pipeline which has already been permanently installed. These can be isolated from the fluid flowing through the pipeline so that a capacitive signal tap is produced, or they can make electrical contact with the fluid flowing through the pipeline, so that a conductive signal tap is produced.

In one highly advantageous embodiment of the invention, the magnet system is fitted together with at least one coil and a magnetic return path within an encapsulated housing and can be fitted to the pipeline which has already been permanently installed, and surrounds it. This embodiment can be used particularly advantageously for the retrospective fitting of a magnetic-inductive flowmeter according to the invention to a pipeline which has already been permanently installed. This embodiment ensures a very high degree of flexibility with regard to the installation location of the magnetic-inductive flowmeter. Virtually no intervention is required in the pipeline which has already been permanently installed.

In one advantageous refinement of the invention, the encapsulated housing comprises in addition an electronic signal converter or signal transmission assembly. The signal converter or signal transmission assembly may, for example, comprise an impedance converter and a signal preamplifier and/or a filter assembly, as well as assemblies for transmission of the measured signals to a process control centre. By way of example, the signals can in this case be transmitted using two-conductor or four-conductor technology, or else via a fieldbus system. The flow measurement points which are created by a flow measurement device according to the invention in the process pipeline system can thus be linked and networked in a manner which is known in principle to the process control panel or the process control level.

Further advantageous refinements of the invention and further advantages will be found in the described exemplary embodiments.

The invention as well as further advantageous refinements of the invention will be explained and described in more detail with reference to the drawings, in which two exemplary embodiments of the invention are illustrated.

In the figures:

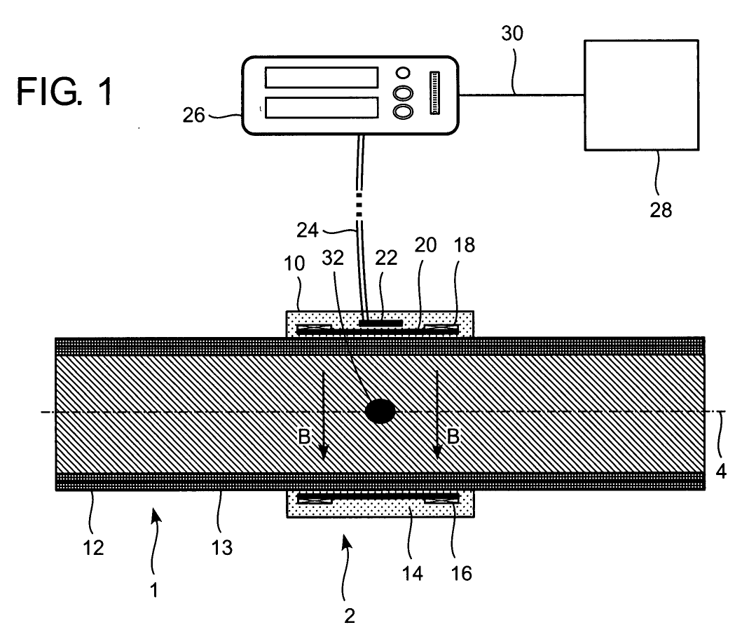

FIG. 1 shows a first embodiment of a magnetic-inductive flowmeter system according to the invention with a conductive signal tap and a pipeline piece of PE-Hd material, schematically in the form of a longitudinal section;

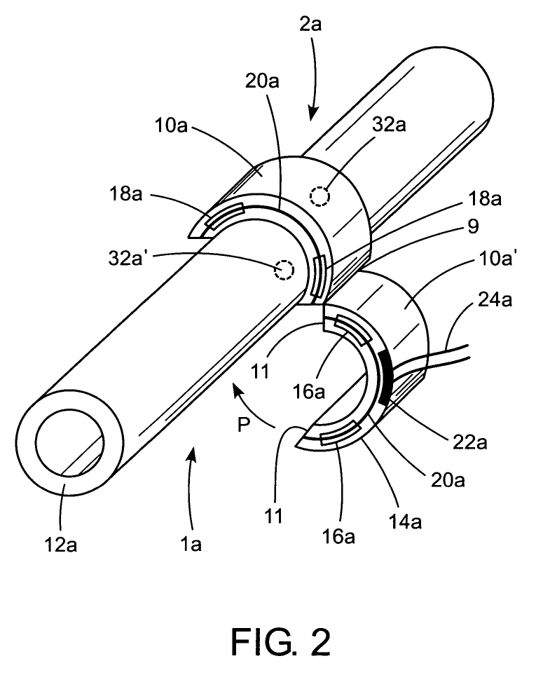

FIG. 2 shows a schematic, perspective illustration of the embodiment shown in FIG. 1, in the state in which the magnet system, which is surrounded in an encapsulated housing, is being fitted to the pipeline, and

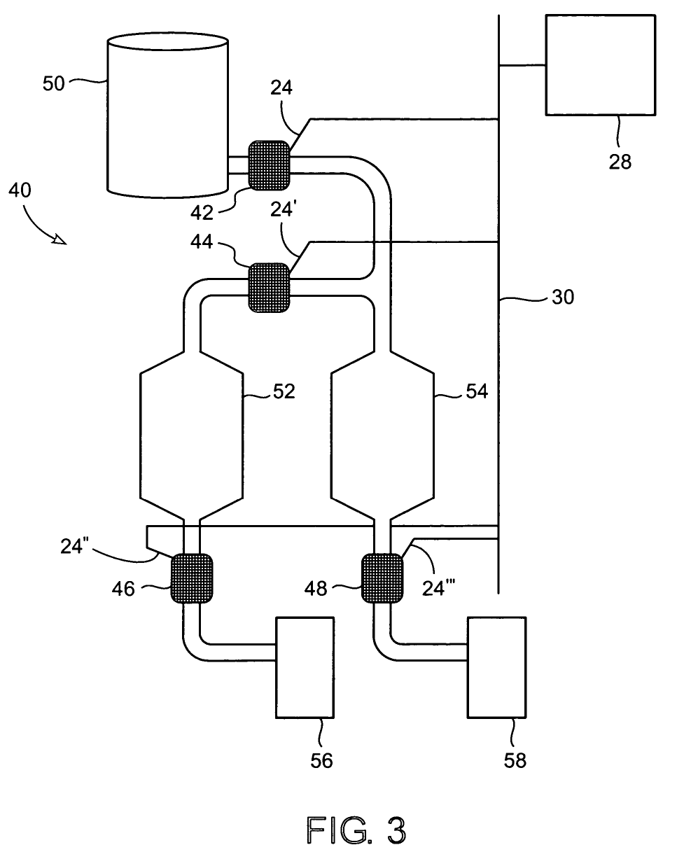

FIG. 3 shows a schematic, exemplary illustration of a process installation with a pipeline system, in which magnetic-inductive flowmeters according to the invention are fitted at four measurement points.

FIG. 1 shows a piece 1 of a process pipeline, whose pipe wall 12 is produced from a PE-Hd material. FIG. 1 shows a longitudinal section through this piece 1 showing, in particular, the aluminium casing layer 13.

An encapsulated housing 10 is fitted to the pipe wall in the zone 2 of the pipeline piece 1 that has been selected as a measurement point, so that it surrounds the pipe wall 12 and rests closely against it. The housing 10 comprises a magnet system 14 and a signal preprocessing and transmission assembly 22. The magnet system 14 comprises circular excitation coils 16, 18 and a ferromagnetic core 20 to provide the magnetic return path. The winding levels of the annular excitation coils 16, 18 run parallel to one another and parallel to the pipe centre axis 4, so that the magnetic excitation field, symbolized by the arrows B, is oriented at right angles to the pipe centre axis 4. Because the illustration is in the form of a longitudinal section, only the section surfaces of the annular coils 16, 18 can be seen.

The ferromagnetic core 20 is formed from a flexible, ferromagnetic metal sheet, which runs parallel to the casing surface of the pipeline piece 1 between the two coils 16, 18, and ensures the magnetic return path. The excitation coils 16, 18 are in this case conventionally wound coils of a flat design. They are fixed together with their electrical supply lines (not illustrated here) in the housing 10, for example by embedding them in an encapsulation compound.

An electronic signal preprocessing and signal transmission assembly 22 is also embedded in the housing in the vicinity of the coils 16, 18. Measurement signal supply lines (not illustrated here) are likewise provided from the signal preprocessing assembly 22 to the measurement electrodes 32. Signal lines 24 are routed from the signal preprocessing assembly 22 to the exterior. A transmitter assembly 26 is connected to these signal lines 24, and is used to produce the link from the measurement point 2 via a fieldbus system 30 to a central process control and instrumentation unit 28. The process control unit 28 in this case has at least one process computer (not illustrated here).

The flowmeter system shown in FIG. 1 has a conductive signal tap. An electrode pair, only one electrode 32 of which is illustrated in FIG. 1, is introduced into the pipeline piece 1 for this purpose. This is done on the completely installed pipeline in such a way that the pipeline is drilled into at the intended point, the electrodes are then inserted, so that they end flush with the inner surface of the pipe. The electrodes 32 are then sealed in the pipe wall 12, for example by means of a sealing glue or by extrusion coating them with some other sealing agent. Sealing and electrode attachment techniques such as these are widely known to those skilled in the art from the prior art.

As is known from magnetic-inductive measurement systems, the measurement electrodes 32 are arranged such that their connecting line is at right angles to the direction of the magnetic field B which is produced by the excitation coils 16, 18. Furthermore, an earthing electrode, which is not illustrated here, is also introduced in the same way as that described above into the pipeline piece 1 at the measurement point 2.

The aluminium casing layer 13, which is provided as a diffusion barrier in the pipe composed of PE-Hd material, is used as a screening layer for the magnetic-inductive meter as shown in FIG. 1. As is known, the purpose of a screening layer such as this is to screen the electrical field between the measurement electrodes 32, which is relatively weak, from the electrical field of the excitation coils 16, 18, in order to ensure interference-free measurement. When using a PE-Hd pipe, as is shown in FIG. 1, there is no need to fit a screening layer such as this separately because the diffusion barrier layer that is already provided in the PE-Hd pipe can be used for this purpose. In this case, care must be taken when fitting the electrodes 32 to ensure that they are brought into contact with the diffusion barrier layer 13 via connecting lines, which are not illustrated here.

The magnetic-inductive flow measurement is dependent on the magnet system being positioned with very high precision and is dependent in particular on little rotation, if high measurement accuracy is intended to be achieved. As mentioned above, if appropriate care is taken in the winding and construction of the magnet system in the housing 10, the geometric precision which can be achieved is very high by the fixing of the magnet system 14 in this housing 10, for example by embedding it in a casting resin. In particular, the magnet system can no longer rotate once it has been fixed in the housing 10. Accurate positioning of the magnet system 14 in the housing 10 with respect to the electrodes 32 can be accomplished easily for example by positioning marks which are fitted to the pipeline together with the electrodes.

The transmitter assembly 26 can itself contain a versatile functional subassembly for signal processing, for further filtering, for temporary storage and for transmission. The signals can be transmitted, for example, via a bus cable, in which case the transmitter assembly 26 has appropriate assemblies for implementation of the respectively required bus transmission protocol, else can be implemented without the use of wires, for example by means of a radio transmitter. FIG. 2 shows the retrospective fitting of a housing with a magnet system 14a introduced into it and with the signal preprocessing assembly 22a, by way of example on a pipeline 1a which has already been permanently installed. Identical parts, assemblies or parts or assemblies having the same effect have the same reference symbols in FIG. 2 as in FIG. 1, but with the letter “a” added to them.

The encapsulated housing which contains the magnet system, as shown in FIG. 2, is formed from two housing halves 10a, 10a′ in the form of shells. The two housing halves 10a, 10a′ are connected to one another by means of connecting hinge 9 such that they can be folded. The first housing half 10a in this case contains one coil 18a with the first part of the ferromagnetic core 20a, and the second housing half 10a′ contains the second coil 16a with the second part of the ferromagnetic core 20a, as well as the signal preprocessing and transmission unit 22a. Signal cables 24a are routed from here to the exterior.

The internal contour of the encapsulated housing that is formed from the two housing halves 10a, 10a′ is designed such that the two housing halves 10a, 10a′ closely surround the pipeline 1a on the outside once they have been joined together. The two parts of the ferromagnetic core 10a are arranged within the housing halves 10a, 10a′ in such a way that the second housing half 10a′ is folded up onto the first housing half 10a in the direction of the arrow P, so that the two housing shells 10a, 10a′ complement one another to form the annular encapsulated housing, closing the magnetic return path at the abutting surfaces 11, and thus also closing the magnetic circuit.

The dashed-line circumferential contours 32a, 32a′ in FIG. 2 also show the two measurement electrodes located in their position within the measurement point zone defined by the encapsulated housing 10a, 10a′. The electrodes 32a, 32a′ have been introduced into the pipe wall 12 before the encapsulated housing was fitted from the outside, together with the magnet system, on the pipe wall. FIG. 2 shows a stylized illustration of the electrodes 32a, 32a′, in which both are concealed. The electrode 32a is concealed by the housing 10a, while the electrode 32a′, which is opposite the electrode 32a, is concealed by the pipe 12a. The electrodes 32a, 32a′ are connected to the signal preprocessing unit 22a within the encapsulated housing while the housing is being fitted on the pipe wall by means of plug connections, which are already provided on the housing inner surface and on the electrodes 32, but are not illustrated here.

The capability to fit the magnet system as shown schematically in FIG. 2 illustrates the major advantage of the magnetic-inductive meter according to the invention. There is no need to cut open the measurement pipeline 1a in order to fit the magnet system in the encapsulated housing, because the two housing halves 10a, 10a′ can be folded open on their connecting hinge 9 to such an extent that they can be fitted even retrospectively at any desired point there, and without any effort on the pipeline 1a which has already been completed and permanently installed.

FIG. 3 shows a schematic, exemplary illustration of a process installation having a pipeline system 40 which has already been permanently installed, in which four flow measurement points 42, 44, 46, 48 have been created by means of magnetic-inductive flowmeters according to the invention. The schematic exemplary illustration of a process installation in FIG. 3 comprises a reservoir 50 in which a liquid substance is stored. The liquid substance is passed through the pipeline system 40 out of the reservoir 50 into two reactors 52, 54. The substance is processed to form different end products in each of the reactors, and is then stored and kept in intermediate storage containers 56, 58. Magnetic-inductive meters, in each case as described above in FIG. 1 and FIG. 2, are formed and fitted at the measurement points 42, 44, 46, 48. The signal lines 24, 24′, 24″, 24′″ of the magnetic-inductive meters are connected at the measurement points 42, 44, 46, 48 to a fieldbus system 30, which is connected to the process control and instrumentation unit 28 with the process computer integrated in it. The flow data produced by means of the flowmeters according to the invention from the process pipe system 40 is evaluated and processed further in the process control unit 28, for example for balancing, quality monitoring or the like.

The pipeline system 40 in the schematic process installation as shown in FIG. 3 is composed of a plastic, for example of a polyethylene based on PE-Hd. As an alternative to the procedure described above of retrospective fitting of the magnetic-inductive meters to the pipeline 40 which has already been permanently installed, it would also be possible to fit magnetic-inductive flowmeters according to the invention in each case to separate pipeline pieces composed of the same plastic material from which the pipeline system 40 is formed. These pipeline pieces which have been prepared and provided with the magnetic-inductive meters in the manner according to the invention would then be installed in the pipeline system during completion of the process pipeline system 40, using the same connection technique as that used in any case for construction of the pipeline system 40. In the case of plastic pipes, this could, for example, be a plastic welding technique or the use of plug-in sleeves for connection of the pipe pieces.

List of reference symbols

| | |
|---|---|
| 1, 1a | Pipeline piece |
| 2, 2a | Measurement point |
| 4 | Tube centre axis |
| 9 | Hinge |
| 10 | Encapsulated housing |
| 10a, 10a′ | First and second housing |
| | halves |
| 11 | Abutting surface |
| 12, 12a | Pipe wall |
| 13 | Aluminium casing layer |
| 14, 14a | Magnet system |
| 16, 18, 16a, 18a | Excitation coil |
| 20, 20a | Ferromagnetic core |
| 22, 22a | Signal preprocessing unit |
| 24, 24′, 24″, 24′′′ | Signal cables |
| 26 | Transmitter assembly |
| 28 | Process control and |
| | instrumentation unit |
| 30 | Fieldbus system |
| 32, 32a, 32a′ | Measurement electrode, |
| | conductive |
| 40 | Process pipeline system |
| 42, 44, 46, 48 | Measurement points |
| 50 | Reservoir |
| 52, 54 | Reactors |
| 56, 58 | Intermediate storage |
| | container |

1. Magnetic-inductive flowmeter for measurement of the flow of fluid substances through a pipeline which is already permanently installed in situ and in which a fluid is at least temporarily flowing, wherein a piece of the pipeline which is already permanently installed in situ is a part of the flowmeter.

2. Magnetic-inductive meter according to claim 1, wherein an electrode arrangement is introduced into the piece of the pipeline which is already permanently installed in situ, and a magnet system is fixed to the piece in the area of the electrode arrangement.

3. Magnetic-inductive flowmeter according to claim 2, in which the electrode arrangement is introduced in the piece and the magnet system fixed to the piece before the final installation of the pipeline.

4. Magnetic-inductive flowmeter according to claim 2, in which the electrode arrangement is introduced in the piece and the magnet system is fixed to the piece retrospectively after final installation of the pipeline.

5. Magnetic-inductive flowmeter according to claim 2, in which at least the piece is a plastic tube composed of polyethylene with an additional diffusion barrier which is formed by an aluminium casing layer and is used a screening layer for the measurement voltage with respect to the excitation voltage of the magnet system on introduction of the electrode arrangement.

6. Magnetic-inductive flowmeter according to claim 2, wherein the electrode arrangement comprises measurement and earthing electrodes which are introduced in a fluid-tight manner into the wall of the piece of the pipeline which has already been permanently installed.

7. Magnetic-inductive flowmeter according to claim 6, wherein the measurement electrodes are isolated from the fluid flowing through the pipeline, so that a capacitive signal tap is produced.

8. Magnetic-inductive flowmeter according to claim 6, wherein the measurement and earthing electrodes make electrical contact with the fluid flowing through the pipeline, so that a conductive signal tap is produced.

9. Magnetic-inductive flowmeter according to claim 2, wherein the magnet system is fitted together with at least one coil and a magnetic return path within an encapsulated housing and can be fitted to the pipeline which has already been permanently installed, and surrounds it.

10. Magnetic-inductive flowmeter according to claim 9, wherein the encapsulated housing comprises an electronic signal converter and/or a signal transmission assembly.
